(19) United States
(12) Patent Application Publication
(10) Pub. No.: US 2005/0031056 A1
(43) Pub. Date: Feb. 10, 2005

(54) Dual signal correlation system

(76) Inventor: Richard J. Thomas, Kettering, OH (US)

Correspondence Address: Scott A. Mcbain;Delphi Technologies, Inc., Legal Staff - M/C 480-410-202, P.O. Box 5052, Troy, MI, 48007, US

(21) Appl. No.: 10/637,398

(22) Filed: Aug. 8, 2003

(51) Int. Cl. H04L 27/06

(52) U.S. Cl. 375/343

(57) ABSTRACT

A dual signal correlation system including a component to be monitored and a sensor system for monitoring the status of the component. The sensor system provides at least first and second data signals relating to the status of the component. The dual signal correlation system further includes a processing system for receiving, monitoring and selectively modifying the first and second data signals of the sensor system. The processing system compares a current value for the first data signal to a current value for the second data signal, and wherein if the current value for the first data signal is determined not to be correlated or is determined to be uncorrelated with the current value for the second data signal, a previously measured value for the first data signal, instead of the current value for the first data signal, is used for subsequent processing.

This invention was made with government support under Contract No. 95839. The Government may have certain rights in this invention.

The present invention is directed to a dual signal correlation system, and more particularly, to a dual signal correlation system which can determine whether two signals are not correlated and, if desired, take or institute corrective action.

### BACKGROUND

When monitoring the status of a component, such as a movable component, various data signals relating to the status of the component may be provided to a controller. Oftentimes, the various data signals may be related to each other. For example, in the case of a brake caliper, the position of the caliper may have a mathematical and/or empirical relationship to the force applied by the caliper to a brake pad. Similarly, the position of the brake pad may have a mathematical and/or empirical relationship to the force applied by the brake pad to a rotor. The output of sensors measuring both force and position of the caliper and/or brake pad may be provided to the controller in a closed loop feedback system.

Due to various causes, at least one of the sensors which provides one of the data signals may not dependably provide a valid data signal, or may provide valid data signals less often than the other sensor. When the system is provided with an invalid signal, degradation of the closed loop actuator operation may result. The invalid signals provided by a sensor can be caused by various factors, including electromagnetic compatibility issues, manufacturing limitations, sensor technology limitations, packaging constraints, less robust components, etc.

Traditionally, linear infinite impulse response filters, as well as finite impulse response filters, have been used to address such issues by filtering the output of the sensor(s). However, systems including such impulse response filters can experience significant time delay of the feedback signal and attenuation of desired signal bandwidth. Furthermore, system models may be created and utilized, but such models require increased levels of processor through-put.

Accordingly, there is a need for an improved system for providing dynamic correlation/correction between two feedback signals or outputs.

### SUMMARY

In one embodiment, the present invention is a dual signal correlation system or filter for correlating/correcting first and second data signals. The dual signal correlation system may determine whether the data signals are correlated, and if not, the system may use the previously measured or previously stored value(s) for at least one of the data signals.

In particular, in one embodiment, the invention is a dual signal correlation system including a sensor system for monitoring the status of a component. The sensor system provides at least first and second data signals relating to the status of the component. The dual signal correlation system further includes a processing system for receiving, monitoring and selectively modifying the first and second data signals of the sensor system. The processing system compares a current value for the first data signal to a current value for the second data signal, and if the current value for the first data signal is determined not to be correlated or is determined to be uncorrelated with the current value for the second data signal, a previously measured value for the first data signal, instead of the current value for the first data signal, is used for subsequent processing.

Other objects and advantages of the present invention will be apparent from the following description and the accompanying drawings.

### BRIEF DESCRIPTION OF THE DRAWINGS

FIG. 1 is a closed loop feedback system diagram;

FIG. 2 is a modified closed loop feedback system diagram illustrating in general one embodiment of the present invention;

FIG. 3 is a flow chart illustrating in general one embodiment of the present invention;

FIG. 4 is a flow chart illustrating, in greater detail, one embodiment of the present invention;

FIG. 5 is a flow chart illustrating, in greater detail, one embodiment of the present invention;

FIG. 6 is a flow chart further illustrating a step or block of the flow chart of FIG. 5;

FIG. 7 is a flow chart further illustrating a step or block of the flow chart of FIG. 5; and

FIG. 8 is an initialization flow chart which may be used prior to use of the flow chart of FIG. 5.

### DETAILED DESCRIPTION

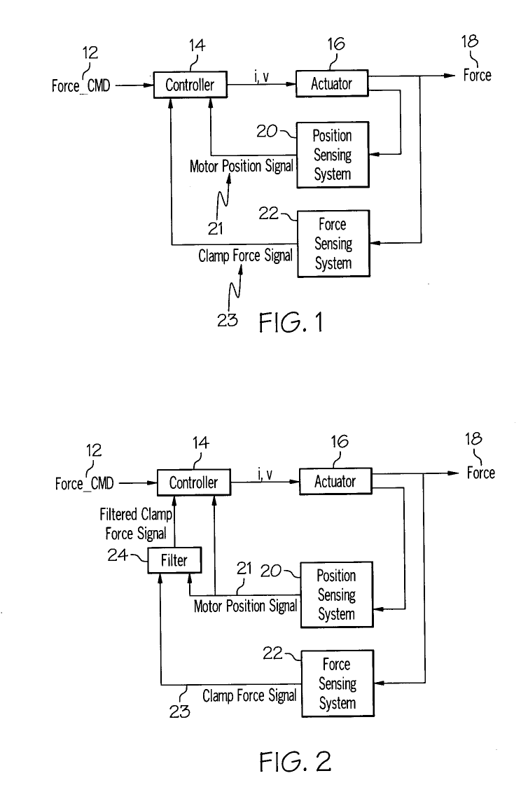

As shown in FIG. 1, in a standard loop feedback system, a force command 12 (“Force_CMD”) is fed as an input to a controller 14 which provides outputs to an actuator 16. The force command 12 may be a target or request force which is desired to be applied by one component to another. The actuator 16 may be part of, or directly control movement of, a movable component. The system may seek to match the force 18 output by the system to the input force 12.

For example, in one embodiment, the movable component is a caliper of a brake or a brake system, wherein movement of the caliper causes an associated brake pad to move closer to or further away from an associated rotor. The illustrative example of a caliper or clamp for a brake or brake system will be considered as an example throughout this application. However, it should be understood that the movable component can be any component which is movable wherein the status of the movable component is desired to be tracked. Thus, the example of a caliper, brake, rotor and brake system provided herein is for illustrative purposes only, and the system of the present invention can be used with nearly any movable component that is desired to be tracked or sensed.

Returning to FIG. 1, the controller 14 can provide signals, for example, a current i and a voltage v to the actuator 16. The controller 14 can be any of a wide variation of controllers, processors, CPUs, circuitry, electronic devices, electronic devices programmed with software, and the like. The actuator 16 can convert the current i and voltage v from the controller 14 into movement (or non-movement) of the caliper (i.e., movement of the caliper towards or away from an associated pad and/or rotor, or no movement of the caliper). When the controller 14 provides signals to move the caliper toward the pad (and thereby move the pad toward the rotor), the system may be considered to be in the “apply” state (i.e., a user or the system is applying the brakes). The system may be considered to be in the apply state when the clamp force of the brake system is greater than or equal to zero and is increasing.

When the controller 14 provides signals to move the caliper such that the pad is pulled away from the rotor, the system may be considered to be in the “release” state (i.e., a user or the system is releasing the brakes). Thus the system may be considered to be in the release state when the clamp force of the brake system is greater than zero and is decreasing. Finally, when the controller 14 provides signals such that the caliper and/or pad should realize a constant, non-zero clamp force, the system may be considered to be in the “hold” state (i.e., a user or the system is “holding” the brakes). Thus the system may be considered to be in a hold state when the clamp force of the brake system is greater than zero and is not changing, or is changing at a low rate.

The brake system may include at least two sensors for monitoring the status or change of various qualities of the caliper. For example, in the illustrated embodiment, a position sensor or position sensing system 20 may be an optical sensor that can sense the position of the caliper, and a force sensor or force sensing system 22 may be a strain gage that can be used to determine the force applied by a caliper to the pad, although the sensors 20, 22 may take any of a wide variety of forms. The output 21 from the position sensing system 20 (i.e., the measured position of the caliper) and the output 23 from the force sensing system 22 (i.e., the measured forced applied by the caliper or pad) are then fed to the controller 14. The controller 14 can then utilize the outputs 21, 23 from the position sensing system 20 and the force sensing system 22 as feedback so that operation of the controller 14 and the brake system can be optimized.

As shown in FIG. 2, in one embodiment of the present invention, an additional block 24 is added in the feedback line from the force sensing system 22 to the controller 14, and the output 21 of the position sensing system 20 may also be fed to block 24. In particular, as will be discussed in greater detail below, if the output 23 of the force sensing system 22 is determined at block 24 to be invalid or not “correlated” with the output 21 of the position sensing system 20, then a substitute value for the output 23 of the force sensing system 22 (i.e., a substitute value for the measured force) is used in place of the measured force 23 to ensure that the feedback to the controller 14 provides more useful values. Thus, the block 24 may act as a filter or correction block or correction means to provide a filtered clamp force signal to the controller 14.

The controller 14 may be or include the filter 24, as well as memory means for storing latched values and a comparator or comparing means for comparing values and carrying out the method described herein. Thus, although FIG. 2 illustrates the filter 24 as being separate from the controller 14, the filter 24 may actually be part of or integrated into the controller 14, in which case the system may appear as shown in FIG. 1.

In the case of a caliper/brake pad/rotor brake system, the relationship between the measured position of the caliper/pad and the measured force applied by the caliper/pad may be able to be dynamically correlated to obtain an improved output from the force sensing system 22. In particular, through empirical evidence or data gathering, it may be assumed that the output, data or values 21 provided by the position sensing system 20 are more consistently accurate, or have more data integrity, than the output, data or values 23 provided by the force sensing system 22.

Accordingly, in one embodiment of the present invention, the current or most recent values 21 for the output from the position sensing system 20 are compared to the current or most recent output 23 for the force sensing system 22. If the output 23 (or processed output) of the force sensing system 22 is determined to be “correlated” with respect to the output 21 (or processed output) of the position sensing system 20, then the actual measured force values 23 may be used for subsequent processing. If, on the other hand, the output 23 from the force sensing system 22 is determined not to be correlated with the output 21 from the position sensing system 20, then a previously stored value (i.e., a “latched value” ) for the output of the force sensing system 22 may be substituted or used for the current measured value 23.

Both the position sensor 20 and force sensor 22 may be configured to supply data, or data signals, regarding the position and force, respectively, of the measured caliper/pad at regular time intervals. The time intervals may be relatively small such as, for example, 1/1000^{th} of a second so that the system can monitor the status of the caliper/pad every millisecond. Of course, however, the measured time interval can vary widely and can be selected to match the system requirements as desired. Further, the position sensor 20 and force sensor 22 may be synchronized such that they each send a data signal to the controller 14 at the same time. In this manner, each signal 21, 23 sent from the position 20 and force 22 sensors may be processed and analyzed in a loop or cycle. The next subsequent set of data sent 21, 23 from the position 20 and force 22 sensors may then be analyzed in another loop or cycle. Thus, the “current” values for position and force may be the most recent values 21, 23 supplied by the position 20 and force 22 sensors which are used as a basis for calculation in a current loop or cycle of the controller 14 or method described herein.

However, it should be understood that the data signals sent 21, 23 by the position 20 and force sensor 22 may not necessarily be synchronized. The position 21 and force 23 signals may be asynchronous with respect to each other and/or may be sampled at different rates (i.e., as an example, 2 ms for the position signal 21 and 1 ms for the force signal 23). Further, the position 21 and force 23 signals may be sampled at variable rates (i.e. the time between samples may be controlled and/or varied). It should be understood that the position 21 and force 23 signals may also be analog signals.

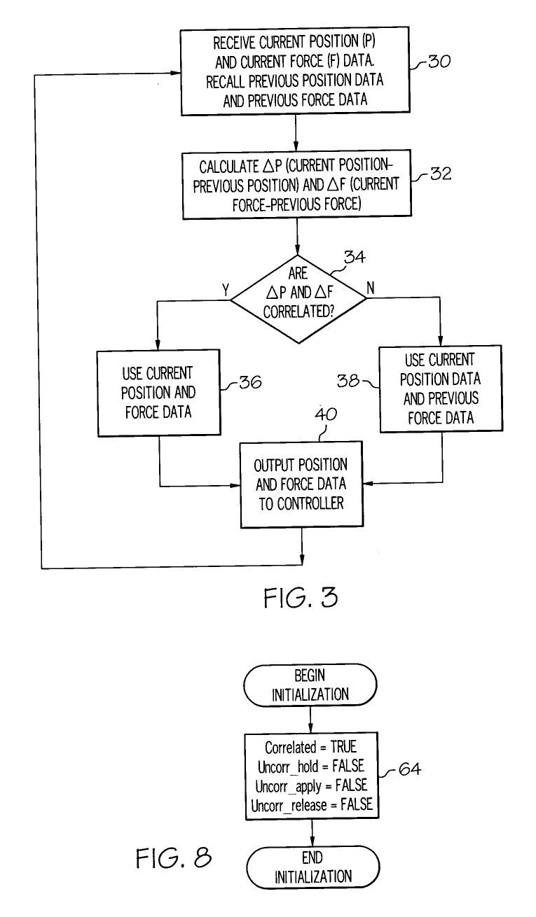

FIG. 3 is a flow chart illustrating one embodiment of the present invention implementing the algorithm outlined above. In particular, as shown in block 30 of FIG. 3, the system or controller first receives current position (P) data and current force (F) from the position sensor 20 and force sensor 22, respectively (i.e., as data signals 21, 23). Block 30 of FIG. 3 also specifies that previous position data and previous force data (that is, data from previous loops or cycles) may be recalled. The term “previous” can mean data from the most previous cycle, or the second most previous cycle, third most previous or beyond, counting backwards as many cycles as may be desired.

Next, at block 32 ΔP and ΔF are calculated by, for example, a comparator by comparing the current values 21, 23 and previous values for position and force. As noted above, the “previous position” and “previous force” can be previous stored values or a combination thereof. ΔP and ΔF can be calculated using various or selected ones of the previous values and may involve further calculations besides merely determining a mathematical difference. For example, after ΔP and ΔF are calculated, various time derivatives for P and F may be calculated.

For example, in one case, ΔP can be calculated by subtracting the most recently measured (non-current) position from the most recently measured (current) position, and similar steps may be used to calculate ΔF. In another case, Euler's approximation of the first time derivative of a filtered version of the position and force signals 21, 23 may be used as ΔP and ΔF. Further, besides various calculations which may be carried out, various derivatives may be determined by analog methods, such as analog circuitry. Additionally, various other methods of determining first time derivatives, or second, third or more derivatives may be utilized. In this manner, ΔP and ΔF may present a picture of the dynamic status of the measured position and force of the caliper/pad (i.e., how quickly or slowly position and force are increasing, decreasing, etc.).

Next, at block 34 of FIG. 3, it is determined whether ΔP and ΔF are correlated. Determination of “correlation” may involve a wide variety of methods. For example, in one embodiment, the determination of correlation is dependent upon the status of the caliper, and/or pad and/or brake system. More particularly, in one embodiment when the system is in its “apply” position, a user or system is applying the brakes, in which case it is expected that the position and force of the caliper/pad would both be increasing (for the calculations and examples herein, it is assumed that movement of the caliper toward the pad (and thereby movement of the pad towards the rotor) increases the position of the caliper). Thus, under this set of circumstances, when the system is in its apply state, ΔP and ΔF may be considered to be correlated if ΔP and ΔF are both positive.

Alternately, when the caliper/brake system is in a release position, it may be assumed that the user or the system is or has released the brakes, in which case it is expected that both the position and force of the caliper/pad would be decreasing. In this case, ΔP and ΔF may be considered to be correlated when ΔP and ΔF are both negative.

Finally, when the caliper/brake system is in the “hold” state, it may be assumed that the brakes are neither being applied nor released and ΔP and ΔF may be considered to be correlated when they are both zero (or zero within certain tolerance limits). Thus, broadly speaking, ΔP and ΔF may be considered to be “correlated” when they have the same correct “sign” (i.e., positive, negative or zero). Further alternately, ΔP and ΔF may be considered to be correlated when they are considered to fall within certain numerical limits of each other. For example, for a given position of the caliper/pad, or for a given ΔP, an expected force or ΔF may be known or calculated. Accordingly, if the measured force or resultant ΔF falls within the range of the expected values for F and/or ΔF, the system may be considered to be correlated. Of course, a wide variety of data processing methods may also be used to determine “correlation” depending upon the desires and needs of the user/operator.

The system may include various safety checks included or incorporated therein, and will be discussed in greater detail below. However, broadly speaking, the safety checks may, for example, cause the system to use the sensed value for force, even if the position and force or ΔP and ΔF symbols are not correlated, upon certain conditions. For example, if sufficient time has elapsed since an actual, measured value for the force signal has been used, then the system may be considered to be correlated, if even for a single loop or cycle, to update the force value. In other words, the system may periodically “update” the stored or latched value for force to ensure that the latched signal used for force does not become too old or “stale.” The force signal may also be updated if the measured force value deviates sufficiently from the latched value, or if the state of the system changes, etc.

If at block 34 ΔP and ΔF are determined to be correlated the system proceeds to block 36 and the current values for position and force data (i.e., the current measured values 21, 23 output from the position sensor 20 and force sensor 22) may be used for subsequent processing. Alternately, if at block 34 it is determined that ΔP and ΔF are not correlated, at block 38 previous force data may be used as, or substituted for, the current force data 23. In other words at block 38, a previously stored, or latched, value for the force data may be substituted for the currently measured value 23. In this case, the current value 21 of the position sensor 20 may be used as the output of the position sensor 20, even if it is determined that the force or ΔF values are not correlated with the position or ΔP values.

The “previous” force data substituted at this step 38 can be any of a wide variety of values. However, at one embodiment, the latched force value is the force data measured during the most recent loop or cycle in which ΔP and ΔF were determined to be correlated. In other words, the last “valid” force signal may be substituted at block 36. Next, as shown at block 40 the position and force data is output to the controller 14, and the system returns to block 30 and repeats for the next loop or cycle of provided data.

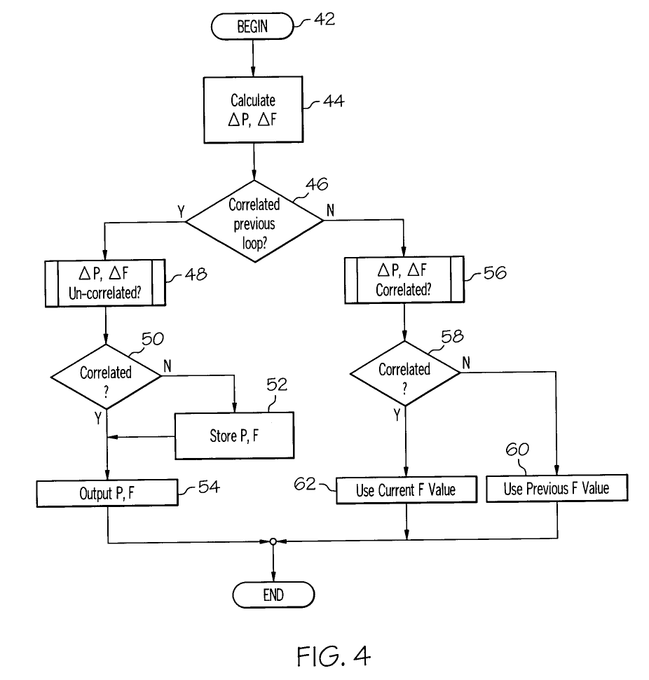

FIG. 4 illustrates in greater detail another embodiment of the system of the present invention. The system begins at block 42 and at block 44 ΔP and ΔF are determined by any of a wide variety of methods as discussed above. Next, at block 46, it is determined whether the system was correlated in the previous loop or cycle.

If it is determined that the system was correlated in the previous loop, then it is determined, at block 48, if ΔP and ΔF are now uncorrelated. Similar to a determination of correlation, the determination of “uncorrelation” may be determined by any of a wide variety of calculations, comparisons, analyses, etc. involving current values for position and force, previous values for position and force, various time derivatives, etc. However, broadly speaking, determining uncorrelation in this step 48 is to determine whether the measured position and force, or ΔP and ΔF, are sufficiently related or correlated within certain parameters or ranges.

Next, at block 50, if the position and force values or ΔP and ΔF are determined to be correlated (or, correspondingly, not uncorrelated) then at block 52 the most current measured position and force values are stored or “latched,” and identified as the latched position and force values. Because the system is now known to be uncorrelated, these stored or latched values (particularly the latched force value) may be used until the system is again determined to be correlated. Alternately, rather than storing the current measured values for force and position as the latched value, values for force and position from a previous loop (i.e. the most recent, previous loop) may be used as the latched values at step 52. Next, at block 54, the sensed force and position values are provided as feedback to the controller 14 and used for subsequent processing.

Returning to decision block 46 of FIG. 4, if it is determined that the system was not correlated during the previous loop or cycle, then the system proceeds to block 56 wherein the system determines whether the position and force, or ΔP and ΔF, are now correlated. If, at block 58, it is determined that position and force or ΔP and ΔF are not correlated, then at block 60 a previously stored value for the force (i.e., from block 52) is substituted for the most recently measured force value. Alternately, if at block 58 it is determined that position and force signals, or ΔP and ΔF, are correlated, then at block 62 the current, measured value for the force may be used.

Thus, the flow chart of FIG. 4 differs from that of FIG. 3 in that the system of FIG. 4 separates out determinations of “correlation” and “uncorrelation” into two separate steps 50, 58. In this manner, greater control over the system can be instituted because determining correlation and uncorrelation can be separately controlled (i.e., different tests and/or thresholds may be applied depending upon the status of the system).

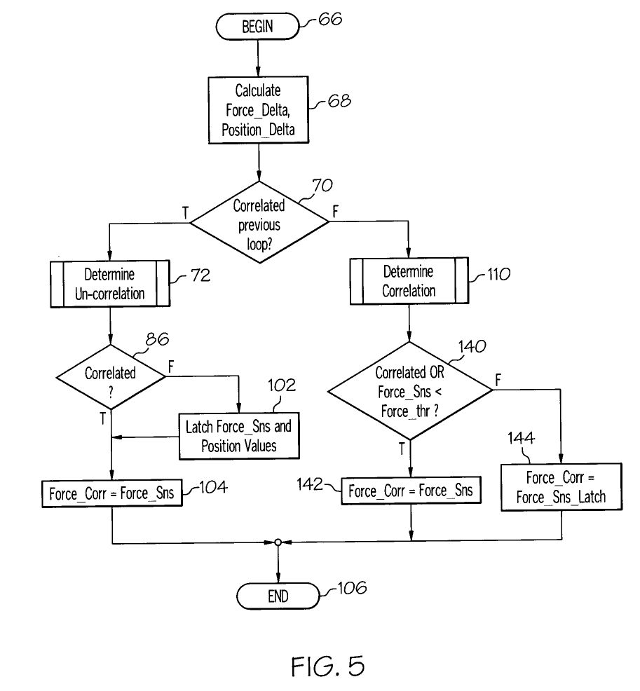

The flow chart of FIG. 5 illustrates the system in greater detail and uses certain variables which will be described herein for one illustrative embodiment of the present invention. Prior to utilizing the flow chart of FIG. 5, an initialization flow chart, as shown in FIG. 8, may be implemented to initialize certain variables used in the flow chart of FIG. 5. The meaning of the variables of block 64 of FIG. 8 will be explained and more fully understood with reference to the discussion below. However, broadly speaking, the variable Correlated pertains to the status of the system as either correlated or uncorrelated. The variable Uncorr_hold pertains to whether the system entered the uncorrelated state while the system was in the hold state. Similarly, the variables Uncorr_apply and Uncorr_release pertain to whether the system entered the uncorrelated state while in either the apply or release state, respectively.

Returning to FIG. 5, the system begins at block 66, and at block 68 Force_Delta (i.e., ΔF) and Position_Delta (i.e., ΔP) are calculated. As noted above, ΔF and ΔP may be a simple mathematical difference between the current sensed force value and the previously measured force value, or they may represent first time derivatives, or a combination of first, second, third or more time derivatives, etc. Further, the methods for determining ΔF may differ from those for determining ΔP.

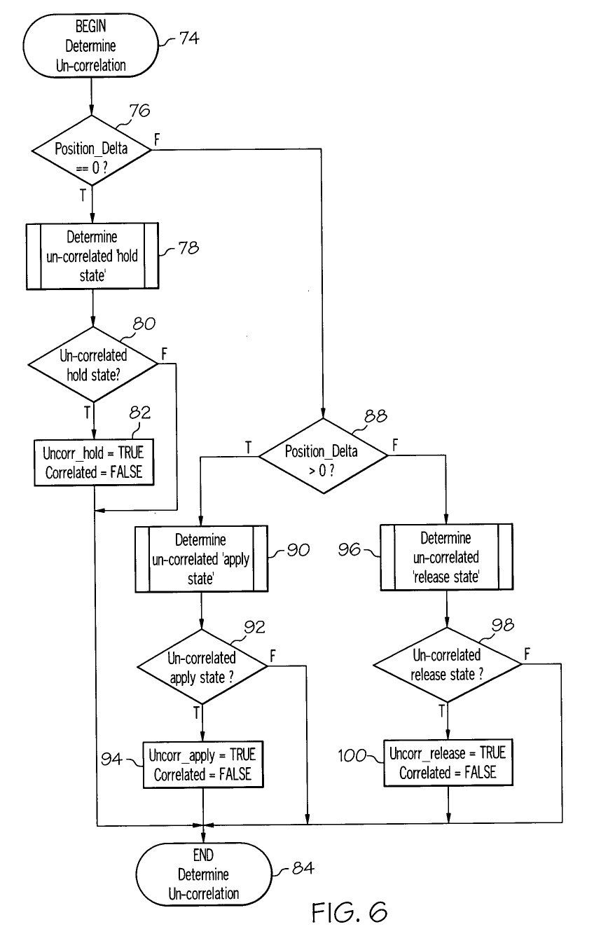

Next, at block 70, it is determined whether the system was correlated during the previous loop or cycle. If, at block 70, it is determined that the system was correlated in the previous loop, then at block 72 if it is determined whether the system is now “uncorrelated.” In other words, the status of the variable “Correlated” is determined. Further discussion of the steps which may be carried out at block 72 are shown in FIG. 6.

Turning to FIG. 6, the system begins at block 74 for determining whether the system should now be classified “uncorrelated.” At decision step 76 of FIG. 6, it is determined whether Position_Delta is equal to zero. This decision step at block 76 is used to determine whether the system is in a “hold” state. In other words, when the system is in its hold state, the position of the caliper/pad should not be changing and ΔP should be zero. As a practical matter, it may be determined whether a Position_Delta is equal to zero within a certain range or tolerance around zero to accommodate the imperfect nature of position sensing systems.

If, at block 76, it is determined that the Position_Delta is equal to zero (within a predetermined tolerance), then, at block 78, it is determined whether the system is uncorrelated according to a predetermined set of conditions for use when the system is in the hold state.

As discussed above, various tests may be applied in order to determine uncorrelation when the system is in the hold condition. In one embodiment, determination of whether ΔP and ΔF are uncorrelated while the system is in the hold state may be determined by the following logical relational statement or “equation” (note that the logical relational statements listed herein are generally denoted as “equations” for conciseness):

(Equation 1)

| | |
|---|---|
| 1 | {Position_Delta ˜= 0 AND |
| 2 | ABS(Force_Sense_Delta) ≧ Force_Sense_Delta_hin_thr |
| | AND |
| 3 | ABS(Force_Sense_Delta_old) ≧ Force_Sense_Delta_hino_thr |
| | AND |
| 4 | ABS(Force_Sense_Delta_old2) ≧ Force_Sense_Delta_hino2_thr |
| | AND |
| 5 | ABS(Force_Sense_Delta_old3) ≧ Force_Sense_Delta_hino3_{—} |
| | thr} |

Line 1 of Equation 1 determines whether Position_Delta is equal to (or about equal to) zero. Accordingly, step 1 of Equation 1 may merely be a redundant check with regard to block 76 of FIG. 6.

Next, at line 2 of Equation 1, it is determined whether the absolute value of Force_Sense_Delta is greater than or equal to Force_Sense_Delta_hin_thr. This step of Equation 1 determines whether ΔF is greater than a predetermined threshold value for ΔF. In other words, line 2 of Equation 1 checks whether the absolute value for ΔF exceeds a threshold. Lines 3, 4 and 5 of Equation 1 check whether ΔF_{old} is greater than or equal to ΔF_{old threshold}; whether ΔF_{old2} is greater than or equal to ΔF_{old threshold2} and whether ΔF_{old3} is greater than or equal to ΔF_{old thesholdr3}. Thus, lines 3, 4 and 5 of Equation 1 look at the three most recent loops or cycles to ensure that the absolute value of ΔF is in fact a large value as a distinct, recognizable trend. If all of the requirements (lines 1-5) of Equation 1 are met, then it is known that the ΔP is zero or about zero, while the absolute value of ΔF is not zero or about zero, and thus the system can be determined to be uncorrelated.

The system then proceeds to block 80 of FIG. 6. For example, at block 80, it is determined whether the system is now uncorrelated (i.e., referring to the calculations of block 78). If the system is uncorrelated, then at block 82 the variable Uncorr hold is set to “TRUE” and the variable “Correlated” is set to “FALSE” for subsequent processing. These variables serve as flags to note that the system is not correlated, and that the system became uncorrelated while in the hold state. On the other hand, if at block 80 it is determined that the system is not uncorrelated, block 82 is bypassed. The system then ends the subroutine of FIG. 6 at block 84, and, returns to block 86 of FIG. 5.

Returning to FIG. 6, if, at block 76, it was determined that Position_Delta is not equal to zero (within predetermined limits), then the system proceeds to decision block 88. At decision block 88 it is determined whether Position_Delta is greater than zero (again assuming variable thresholds for determining “zero”). If, at decision block 88, it is determined that Position_Delta is greater than zero, then it is known that position of the caliper/pad is increasing and therefore the system is in the “apply” state. Accordingly, at block 90 it is next determined if the system is uncorrelated using a logical relational statement that applies when the system is in the apply state. In one embodiment, determination of whether the system is uncorrelated while in the apply state may be determined by following equation:

(Equation 2)

| | |
|---|---|
| 1 | {Position_Delta > Position_Delta_ain_thr AND |
| 2 | Force_Sense_Delta ≦ Force_Sense_Delta_ain_thr AND |
| 3 | Force_Sense_Delta_old ≦ Force_Sense_Delta_aino_thr} |

Line 1 of Equation 2 determines whether Position_Delta is greater than Position_Delta_ain_thr. In other words, line 1 of Equation 2 determines whether ΔP is greater than a predetermined threshold (which may be nearly any value, but for illustrative matters may be visualized as zero, or near zero). Accordingly, line 1 in Equation 2 may merely confirm that the system is indeed in the apply state.

Next, at line 2 of Equation 2, it is determined whether ΔF is less than or equal to ΔF_{threshold}. ΔF_{threshold} may be nearly any value, but for illustrative matters may be visualized as zero, or near zero. Thus, lines 1 and 2 can, alone, be used to determine whether ΔP and ΔF are correlated, because when ΔP is greater than its threshold and ΔF is less than its threshold, then the system may not be correlated. Line 3 of Equation 2 determines whether ΔF_{old} is less than or equal to ΔF_{old threshold}. Accordingly, line 3 of Equation 2 provides an additional check to confirm that an older value of ΔF is also below a threshold.

Of course, various other older or current values, or combinations thereof, for checking ΔF and/or ΔP may be used or compared in Equation 2 to determine uncorrelation. It should also be understood that the “thresholds” or tolerances disclosed in Equation 2 may be the same as or different from the thresholds or tolerances of Equation 1, but in general are expected to be independently set and controlled to enable the system/method to be tailored to the characteristics of the brake/sensor system in which it is used. In fact, each of Equations 1-6 discussed herein may include various thresholds and tolerance, and it is to be understood that different and values for the various thresholds or tolerances therein may be used.

Returning block 92 of FIG. 6, if the system is determined to be uncorrelated (i.e., Equation 2 is determined to be true), then at block 94 the variable Uncorr_apply is set to “TRUE” to reflect that the test for determining uncorrelation while the system is in the apply state has been met. Similarly, the variable Correlated is set to “FALSE” to reflect that the system is not in a correlated state. On the other hand, if at block 92 it is determined that the system is not uncorrelated, block 94 is bypassed. The flow chart of FIG. 6 is then terminated at block 84, and the system returns to block 86 of FIG. 5.

Finally, if, at decision block 88 of FIG. 6, if it is determined that Position_Delta is not greater than zero (within a certain tolerance), then it is known that the system is in a release event or state, and at block 96, it is determined whether the system is uncorrelated under the release set of conditions.

In one embodiment, determining whether the system is uncorrelated while the system is in a release state may be determined by the following equation:

(Equation 3)

| | |
|---|---|
| 1 | {Position_Delta < Position_Delta_rin_thr AND |
| 2 | Force_Sense_Delta ≧ Force_Sense_Delta_rin_thr AND |
| 3 | Force_Sense_Delta_old ≧ Force_Sense_Delta_rino_thr} |

Equation 3 is similar in principle to that of Equation 2 discussed above. In particular, line 1 of Equation 3 checks to ensure that the system is in the release state, and lines 2 and 3 of Equation 3 check whether ΔF and ΔF_{old} are greater than or equal to their respective threshold values. If Equation 3 is found to be true, then the system can be considered to be uncorrelated.

If, at block 98 of FIG. 6, it is determined that the system is uncorrelated, then at block 100 the variable Uncorr_release is set to “TRUE” to reflect that the system became uncorrelated while in the release state, and the variable Correlated is set to “FALSE.” On the other hand, if at block 98 it is determined that the system is not uncorrelated, block 100 is bypassed. The system then returns to end block 84 and then to block 86 of FIG. 5.

Returning to FIG. 5, at decision block 86, it is examined whether the system is correlated by, for example, examining the status of the variable Correlated. If the system is determined not to be correlated at block 86 (i.e. the variable Correlated is “FALSE”), then at block 102 the sensed force (i.e., Force_Sns) and sensed position values are “latched” or stored for subsequent processing. The system then proceeds to block 104, wherein the sensed force is used as the correlated force “Force_Corr” for subsequent processing (i.e., provided to the controller 14). Alternately, a latched valve for the force may be provided to the controller 14 at this time. Next, the system returns to the end block 106, and the system returns to the begin block 66 once a new set of values 21, 23 for position and force are received from the position 20 and force 22 sensors.

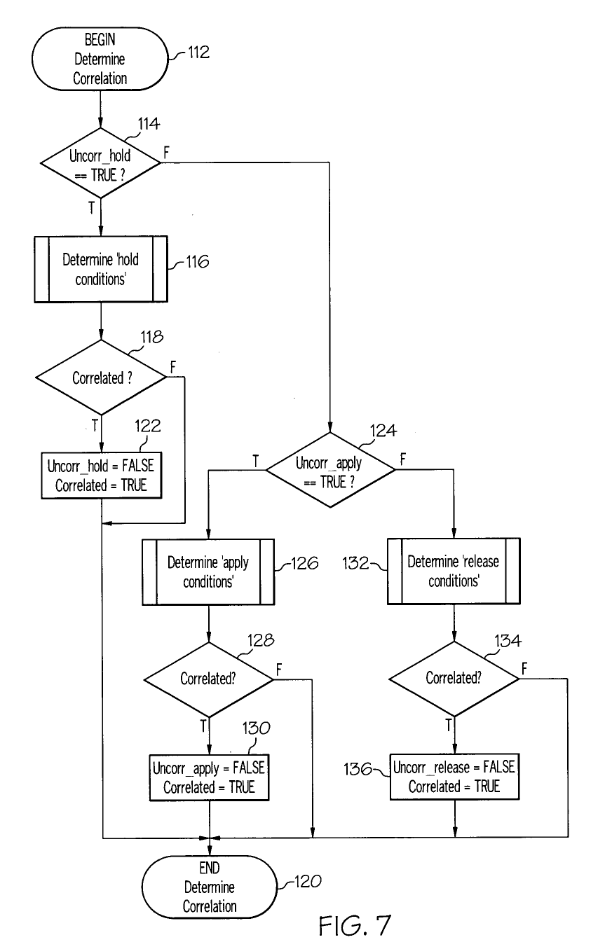

Returning to decision block 70 of FIG. 5, if it is determined that the system was not correlated in the previous loop or cycle, at block 110 it is determined whether the system is now correlated and thus should now be switched to a “correlated” state. Similar to block 72 for determining uncorrelation, block 110 for determining whether the system should now switch to the correlated condition may be dependent upon whether the system is in a release, apply or hold state. FIG. 7 illustrates in greater detail a subroutine which may be used to determine if Uncorr_hold is “TRUE” to determine whether the system is or should now be considered to be correlated at block 110.

As shown in FIG. 7, a method for determining correlation begins at block 112, and at block 114 it is determined whether the variable Uncorr_hold is “TRUE” (i.e. whether the system became uncorrelated while the system was in a hold state). If Uncorr_hold is “TRUE,” then at block 116, it is determined whether the system is now correlated under a predetermined logical relational statement.

Accordingly, in one embodiment of the algorithm or system of the present invention, the test(s) for determining correlation depends upon in which state the system was in when the system became uncorrelated. Thus, for example, if the system entered the uncorrelated state while the system was in the hold state, then the system may be determined to be returned to its correlated state based upon a corresponding set of tests or conditions which apply only when the system entered the uncorrelated state while the system was in the hold state. Similar, and distinct, tests may apply when the system entered the uncorrelated state under the apply and release states, respectively.

In other words, if the system entered the uncorrelated state while the system was in the hold state, then the “hold uncorrelated” test may be used to determine if the system is now correlated, regardless whether the system is now considered to no longer be in the hold state. Similarly, if the system was switched to an uncorrelated state while in the apply or release state, then the corresponding “release uncorrelated” or “apply uncorrelated” tests may be utilized.

In one embodiment, determination at block 116 of whether the system is correlated for the case when the system became uncorrelated while in the hold state may be determined by the following equation:

(Equation 4)

| | |
|---|---|
| 1 | { |
| 2 | {Position_Delta > Position_Delta_ha_thr} AND |
| 3 | { |
| 4 | {Force_Sense_Delta > Force_Sense_Delta_ha_thr AND |
| 5 | Force_Sense_Delta_old > Force_Sense_Delta_hao_thr AND |
| 6 | Force_Sense > Force_Sense_Latch − Force_Sense_tol_had} |
| 7 | OR |
| 8 | {Force_Sense > Force_Sense_Latch − Force_Sense_tol_ha} |
| 9 | } |
| 10 | } |
| 11 | OR |
| 12 | { |
| 13 | {Position_Delta < Position_Delta_hr_thr} AND |
| 14 | { |
| 15 | {Force_Sense_Delta < Force_Sense_Delta_hr_thr AND |
| 16 | Force_Sense_Delta_old < Force_Sense_Delta_hro_thr AND |
| 17 | Force_Sense < Force_Sense_Latch + Force_Sense_tol_hrd} |
| 18 | OR |
| 19 | {Force_Sense < Force_Sense_Latch + Force_Sense_tol_hr} |
| 20 | } |
| 21 | } |

Line 2 of Equation 4 determines whether Position_Delta is greater than a threshold value for Position_Delta to determine whether the position of the caliper/pad is increasing (i.e., the system may be considered to be in an “apply” state).

Lines 4 and 5 of Equation 4 determine whether, over the previous two loops or cycles, the output 23 of the force sensor 22 is sufficiently increasing. In particular, lines 4 and 5 determine whether ΔF is greater than ΔF_{threshold} and ΔF_{old} is greater than ΔF_{old threshold}. The sixth line of Equation 4 determines whether the most recent sensor force data signal 23 is greater than the “latched” force sense data signal minus a tolerance value. In particular, line 6 of Equation 4 may be used to determine whether the sensed value for the force is sufficiently large as compared to the latched value. Thus, line 6 of Equation 4 may be used as a safety check, to check whether the sensed force has sufficiently deviated from the latched value. If each of lines 2-6 are true, then it is known that the position of the caliper/pad is increasing, ΔF and ΔF_{old} are increasing, and the sensed force is greater than or approximately equal to the latched value, and the system may be considered to be “correlated.”

Line 8 of Equation 4 specifies that if the sensed force is greater than the latched force minus a tolerance, then the system may be assumed to be correlated assuming, of course, line 2 of Equation 4 is met. Thus, line 8 is somewhat analogous to line 6 in that the system can check whether the sensed force is greater than or approaching the latched force value. Thus, lines 2 and 8 are determined to be true, then the system may be considered to be correlated to update the latched force value.

Lines 13-20 of Equation 4 provide alternate manner(s) in which the system may be considered to be correlated. Line 13 of Equation 4 determines whether ΔP is less than a threshold (i.e., the system may be considered to be in a release state). In this case, the remaining steps (lines 14-21) of Equation 4 are similar to those of lines 3-10 of Equation 4 discussed above, with various signs reversed, as appropriate. Thus, lines 14-20 of Equation 4 determine whether ΔF is less than threshold, whether ΔF_{old} is less than a threshold, whether the sensed force is less than the latched sensed force plus a tolerance, or whether the sensed force is less than the latched sense force plus a different tolerance.

Returning to the flow chart of FIG. 7, if, at block 118, it is determined that the system is not correlated according to Equation 4 (i.e., Equation 4 is considered to be “FALSE”), the system advances to end block 120, and returns to block 110 of FIG. 5. Alternately, if at decision block 118, it is determined that the system is correlated, then at block 122 the variable Uncorr_hold is set to “FALSE,” and the variable “Correlated” is set to “TRUE” to reflect the fact that the system is no longer considered to have entered the uncorrelated state while the system was in the hold state, and the system is now considered to be correlated. The system then returns to end block 120, and to block 110 of FIG. 5.

Returning to block 114 of FIG. 7, if it is determined that the system did not enter the uncorrelated state during the hold state (i.e. Uncorr_hold is “FALSE”), then the system advances to decision block 124, where it is determined whether the system entered the uncorrelated state while in the apply state (i.e. is Uncorr_apply=“TRUE”?). If so, then at block 126, it is determined whether the system is now correlated under the apply conditions. One method to determine whether ΔP and ΔF are correlated for the case when the system became uncorrelated while in the apply state can be expressed by the following equation:

(Equation 5)

| | |
|---|---|
| 1 | {Position_Delta > Position_Delta_a_thr AND |
| 2 | Force_Sense_Delta > Force_Sense_Delta_a_thr AND |
| 3 | Force_Sense_Delta_old > Force_Sense_Delta_ao_thr AND |
| 4 | Force_Sense ≧ Force_Sense_Latch} |
| 5 | OR |
| 6 | {Position_Delta ≦ 0 AND |
| 7 | Force_Sense > Force_Sense_Latch + Force_Sense_tol_a} |
| 8 | OR |
| 9 | {Position_Delta ≦ 0 AND |
| 10 | Position < Position_Latch − Position_tol_a} |

Line 1 of Equation 5 checks whether ΔP is greater than a threshold. Line 2 of Equation 5 determines whether ΔF is greater than a predetermined threshold and line 3 of Equation 5 checks whether ΔF_{old} is greater than a corresponding predetermined threshold. Next, line 4 of Equation 5 checks whether the sensed force value is greater than or equal to the latched force sense value. Thus, if each of the conditions stated in lines 1-4 of Equation 5 are met, it is known that position is increasing, ΔF and ΔF_{old} are sufficiently large, and the measured force value is greater than or equal to the latched value and is determined that ΔP and ΔF are correlated.

Lines 6 and 7 of Equation 5 specify another set of conditions in which the system may be switched from an uncorrelated state to a correlated state. In particular, if ΔP is determined to be less than or equal to zero (line 6), and the sensed force value is greater than the latched force sensor value plus a predetermined tolerance value then the system may be considered to be correlated. Lines 6 and 7 of Equation 5 may be used as a check to determine that, if the system is no longer in the apply state (i.e., ΔP≦0) and the sensed force is sufficiently greater than the latched force, then the current measured value for the sensor force may be used.

Finally, if the conditions specified in lines 9 and 10 of Equation 5 are met, the system may be considered to be correlated. Line 9 checks whether ΔP is less than or equal to zero, and line 10 determines whether the measured position for the caliper/pad is less than the latched position minus a tolerance. In this manner, lines 10 and 11 of Equation 5 may be used as a check to determine that, if the system is no longer in the apply state and the position of the caliper has moved sufficiently beyond the position associated with the latched force value, then the system may be considered correlated and an updated value for the force sensor may be desired to be used.

Returning to FIG. 7, at decision block 128, it is determined whether the system is correlated under a set of requirements, for example, those of Equation 5 above. If it is determined that the system is correlated (i.e., Equation 5 is “TRUE”), then at block 130 the variable Uncorr_apply is set to “FALSE” and the variable Correlated is set to “TRUE.” Alternately, if at decision block 128 the system is determined not to be correlated, block 130 is bypassed and the changes to the variables Uncorr_apply and Correlated are not instituted. The system then advances to end block 120 of FIG. 7 and block 110 of FIG. 5.

Finally, returning to decision block 124 of FIG. 7, if the variable Uncorr_apply is determined to be false, then it is known that the system entered the uncorrelated state while the system was in the release state. Accordingly, at block 132, it is determined whether the system is correlated under the release conditions.

The following equation or listing of conditions may be used to determine whether the system is correlated at block 132:

(Equation 6)

| | |
|---|---|
| 1 | {Position_Delta < Position_Delta_r_thr AND |
| 2 | Force_Sense_Delta < Force_Sense_Delta_r_thr AND |
| 3 | Force_Sense_Delta_old < Force_Sense_Delta_ro_thr AND |
| 4 | Force_Sense ≦ Force_Sense_Latch} |
| 5 | OR |
| 6 | {Position_Delta ≧ 0 AND |
| 7 | Force_Sense < Force_Sense_Latch − Force_Sense_tol_r} |
| 8 | OR |
| 9 | {Position_Delta ≧ 0 AND |
| 10 | Position > Position_Latch + Position_tol_r} |

Equation 6 is analogous to Equation 5 discussed in detail above, with the exception of the changes of various terminology and signs as will be readily apparent to accommodate changes from the apply conditions to the release conditions. In particular, lines 1-4 of Equation 5 determine whether ΔP is less than a threshold, and whether ΔF and ΔF_{old} are smaller than their respective thresholds, and whether the force sensor value is less than or equal to the latched force sensor value.

Line 6 and 7 of Equation 6 check whether ΔP is greater than or equal to zero, and whether the sensed force value is less than the latched force sensor value minus a predetermined tolerance value. Finally, lines 9 and 10 of Equation 6 to determine whether ΔP is greater than or equal to zero and whether the measured position for caliper/pad is greater than the latched position plus a tolerance. Thus, if lines 1 through 4 are determined to be true, or lines 6 and 7 are determined to be true, or lines 9 and 10 are determined to be true, then Equation 6 is determined, as a whole, to be true and the system may be considered to be correlated.

Returning to FIG. 7, if at decision block 134 the system is determined to be correlated then at block 136 the variable Uncorr_release is set to “FALSE” and the variable Correlated is set to “TRUE.” Alternately, if at decision block 134 it is determined the system is not correlated, then block 136 is bypassed and the changes to the variables Uncorr_release and Correlated are not instituted. The system then progresses to end block 120 of FIG. 7 and block 110 of FIG. 5.

Next, returning to FIG. 5, at block 140, it is determined whether the system is correlated, or if the sensed force (Force_Sns) is less than a threshold value (Force_thr). This alternate check (i.e., line 2 of decision block 140) checks for “sensor saturation” such that if it is determined that the sensed force value is sufficiently low, then the sensed value for the force will be used regardless of any determinations of correlation/uncorrelation. Accordingly, if the conditions of block 140 are determined to be met, then the system progresses to block 142 wherein the sensed force is used for subsequent processing. Alternately, at block 144, the latched value for the force sensor (i.e. the force value stored by the system at block 102) is then used for subsequent processing.

Thus, as can be seen, a wide variety of factors and variables may be considered in order to determine whether the system is correlated/uncorrelated, whether corrective action is required, and how to institute such corrective action. If the system is determined to be uncorrelated, latched values for the force signal may be used. In this manner, the dual signal of the correlation system can provide non-linear filtering of reduced integrity signals, such as a clamp force sensor signal, with less delay relative to linear filtering schemes. Furthermore, the dual signal correlation system of the present invention can attenuate and/or eliminate non-relevant signals, while simultaneously passing relevant signals. Finally, the dual signal correlation system can be easily implemented in a fixed-point processor. Various software, circuitry, controllers, processors, memory means, CPUs and the like may be used to store, implement and/or run the system of the present invention. The system may be implemented as a digital control system/filter with digital inputs and various software/hardware components such as a software programmable processor/microcontroller, or may include various analog components, or could be implemented entirely as an analog system with only electrical hardware circuitry and without a software programmable processor/microcontroller.

Having described the invention in detail and by reference to the preferred embodiments, it will be apparent that modifications and variations thereof are possible without departing from the scope of the invention.

1. A dual signal correlation system comprising:
a sensor system for monitoring the status of a component, said sensor system providing at least first and second data signals relating to the status of said component; and
a processing system for receiving and selectively modifying said first and second data signals of said sensor system, wherein said processing system compares a current value for said first data signal to a current value for said second data signal, and wherein if said current value for said first data signal is determined not to be correlated with said current value for said second data signal or is determined to be uncorrelated with said current value for said second data signal, a previously measured value for said first data signal, instead of said current value for said first data signal, is used for subsequent processing.

2. The system of claim 1 further including a controller, and wherein said processing system provides an output of said processing system to said controller for subsequent processing to determine feedback controls to said component.

3. The system of claim 2 wherein said output includes said current value for said second data signal and, if said current value for said first data signal is determined to not be correlated or to be uncorrelated with said current value for said second data signal, said output includes said previously measured value for said first data signal, and wherein if said current value for said first data signal is determined to be correlated or not to be uncorrelated with said current value for said second data signal, said output includes said current value for said first data signal.

4. The system of claim 1 wherein said current value for said second data signal is used for subsequent processing. The system of claim 1 wherein said processing system includes a comparator for comparing said current value for said first data signal and said current value for second data signal, memory means for storing previously supplied values for said first and second data signals, and correction means for selectively substituting a previously measured value for said current value of said first data signal.

5. The system of claim 1 wherein said processing system is configured such that if said current value for said first data signal is determined to be correlated with said current value for said second data signal, the current values of both said first and second data signals are used for subsequent processing.

6. The system of claim 1 wherein said first and second data signals are physically related to each other.

7. The system of claim 1 further comprising said component, and wherein said component is a movable component.

8. The system of claim 7 wherein said component is a brake caliper operatively coupled to a brake pad, and wherein said first data signal is indicative of a force applied by said caliper to another component or of the force applied by said brake pad to a rotor and said second data signal is indicative of a position of said caliper or said brake pad.

9. The system of claim 1 wherein said sensor system includes two sensors, each of which provides one of said data signals.

10. The system of claim 1 wherein said sensor system provides updated values for said first and second data signals at spaced time intervals.

11. The system of claim 1 wherein said processing system is configured such that said previously measured value of said first data signal used for subsequent processing is the most recent value of said first data signal when said first and second signals were last determined to be correlated.

12. The system of claim 1 wherein said current value for said first data signal is determined not to be correlated or to be uncorrelated with said current value for said second data signal by performing a mathematical operation or operations upon both of said first or second data signals to provide modified values for said first and second data signals and comparing the modified values.

13. The system of claim 12 wherein said mathematical operation or operations includes a derivative of said first and second data signals.

14. The system of claim 13 wherein said derivative is a first time derivative which takes into account previous values for said first and second data signals.

15. The system of claim 12 wherein each modified value includes or incorporates a difference between the current values for said first and second data signals and a previous value for said respective first and second data signals.

16. The system of claim 12 wherein if the signs of said modified values are the same, said first and second data signals are considered to be correlated, and if the signs of said modified values are not the same, said first and second data signals are considered to be not correlated.

17. The system of claim 1 wherein said processing system determines whether said first and second data signals were correlated in a most recent, previous loop.

18. The system of claim 17 wherein said processing system determines if said first and second data signals were correlated in the most recent, previous loop, and if the first and second data signals were correlated then the processing system determines whether said first and second data signals are now uncorrelated using a first set of conditions.

19. The system of claim 18 wherein said processing system determines if said first and second data signals were uncorrelated in the most recent, previous loop, and if the first and second data signals were uncorrelated then the processing system determines whether said first and second data signals are now correlated using a second set of conditions.

20. A feedback system for monitoring and modifying first and second data signals provided to the feedback system, wherein said feedback system is configured to compare a current value for said first data signal to a current value for said second data signal, and wherein if said current value for said first data signal is determined not to be correlated with said current value for said second data signal, a previously measured value for said first data signal, instead of said current value for said first data signal, is output from said system for subsequent processing.

21. A method for providing feedback including the steps of:
receiving from a sensor system current values for first and second data signals;
determining whether said current values for said first and second data signals are correlated, and wherein if said current values for said data signals are determined not to be correlated, a previously measured value for at least one of said data signals is provided for subsequent processing.

22. The method of claim 21 further including the step of providing an output to a controller for subsequent processing to determine feedback controls to a component.

23. The method of claim 22 wherein said output includes said current value for said second data signal and, if said current value for said first data signal is determined to not be correlated with said current value for said second data signal, said output includes said previously measured value for said first data signal, and wherein if said current value for said first data signal is determined to be correlated with said current value for said second data signal, said output includes said current value for said first data signal.

24. The method of claim 23 further including the step of said controller utilizing said output to determine said feedback controls to said component.

25. The method of claim 23 wherein if said current value for said first data signal is determined to be correlated with said current value for said second data signal, the current values of both said first and second data signals are used for subsequent processing.

26. The method of claim 23 wherein said previously measured value of said first data signal used for subsequent processing is the most recent value of said first data signal when said first and second signals were last determined to be correlated.

27. The method of claim 23 wherein said current value for said first data signal is determined not to be correlated with said current value for said second signal by performing a mathematical operation or operations upon both of said first or second data signals to provide modified values for said first and second data signals and comparing the modified values.

28. The method of claim 27 wherein said mathematical operation or operations includes a derivative of said first and second data signals.

29. The method of claim 28 wherein said derivative is a first time derivative which takes into account previous values for said first and second data signals.

30. The method of claim 27 wherein each modified value includes or incorporates a difference between the current values for said first and second data signals and a previous value for said respective first and second data signals.

31. The method of claim 27 wherein if the signs of said modified values are the same, said first and second data signals are considered to be correlated, and if the signs of said modified values are not the same, said first and second data signals are not considered to be correlated.

32. The method of claim 21 wherein said first and second data signals are physically related to each other.

33. The method of claim 21 wherein said sensor system monitors the status of a component, and wherein said first and second data signals are related to the status of said component.

34. The method of claim 33 wherein said component is a brake caliper operatively coupled to said brake rotor, and wherein said first data signal is indicative of a force applied by said caliper to another component or of the force applied by said brake pad to a rotor and said second data signal is indicative of a position of said caliper or of said brake pad.

35. The method of claim 21 wherein said sensor system includes two sensors, and wherein the method includes each of said sensors providing one of said data signals

36. The method of claim 35 wherein said sensor system provides updated values for said first and second data signals at spaced time intervals.

37. The method of claim 21 further including the additional step of determining whether said first and second data signals were correlated in a most recent, previous loop.

38. The method of claim 37 wherein said additional determining step includes determining whether said first and second data signals were correlated in the most recent, previous loop, and if the first and second data signals were correlated then checking whether said first and second data signals are now uncorrelated using a first set of conditions.

39. The method of claim 38 wherein said additional determining step includes determining whether said first and second data signals were uncorrelated in the most recent, previous loop, and if the first and second data signals were uncorrelated then checking whether said first and second data signals are now correlated using a second set of conditions.
